(19) United States
(12) Patent Application Publication
(10) Pub. No.: US 2025/0227088 A1
(43) Pub. Date: Jul. 10, 2025

(54) SECURE ONBOARDING AND MANAGEMENT OF AN IHS

(71) Applicant: Dell Products L.P., Round Rock, TX (US)

(72) Inventors: Bradley K. Goodman, Nashua, NH (US); Mukesh Gupta, Shrewsbury, MA (US); Eric Bruno, Shirley, NY (US)

(73) Assignee: Dell Products L.P., Round Rock, TX (US)

(21) Appl. No.: 18/753,292

(22) Filed: Jun. 25, 2024

Related U.S. Application Data
(60) Provisional application No. 63/618,103, filed on Jan. 5, 2024.

(51) Int. Cl. H04L 9/40; G06F 21/10; G06F 21/33

(52) U.S. Cl. CPC H04L 63/02; G06F 21/1014; G06F 21/33

(57) ABSTRACT

Embodiments provide secure onboarding of an Information Handling System (IHS). A rendezvous service of an onboarding system is provided with an address of an onboarding service and a token that are both to be provided to the IHS. The IHS is powered for the first time upon a transfer of the IHS to an owner of the IHS. Upon the first powering of the IHS, the IHS initiates a connection with the rendezvous service of the onboarding system. The rendezvous service provides the IHS the token and the address of the onboarding service, where the onboarding service is operated on behalf of the owner. The IHS presents the token to a firewall protecting the onboarding service. In response to the presented token being recognized by the firewall, the firewall authorizes onboarding communications by the IHS with the onboarding service in order to configure the IHS for the owner.

### CROSS REFERENCE TO RELATED APPLICATIONS

This application claims the benefit of U.S. Provisional Application No. 63/618,103, filed Jan. 5, 2024.

### FIELD

The present disclosure relates generally to Information Handling Systems (IHSs), and relates more particularly to supporting secure modifications to IHSs.

### BACKGROUND

As the value and use of information continues to increase, individuals and businesses seek additional ways to process and store information. One option available to users is Information Handling Systems (IHSs). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

The Fast IDentity Online (FIDO) Alliance has promulgated a set of security-focused technologies and protocols intended to simplify and enhance cybersecurity. IHSs may perform device authentication using the FIDO Device Onboarding (FDO) protocol. An IHS manufactured to include a digital ownership voucher that defines an “owner” of the IHS and may be used to securely transfer ownership of the IHS as it moves through the supply chain and delivered to an end user. The FDO standard may use the FIDO protocol to automate an initial registration operation of an IHS using a rendezvous server that directs the IHS to an onboarding service that configures the IHS for operation by a user.

### SUMMARY

In various embodiments, method and systems provide secure onboarding of an Information Handling System (IHS). Embodiments may include: providing a rendezvous service of an onboarding system with an address of an onboarding service and a token that are both to be provided to the IHS; powering the IHS for a first time upon a transfer of the IHS to an owner; upon the first powering of the IHS, initiating, by the IHS, a connection with the rendezvous service of the onboarding system; providing, by the rendezvous service, the IHS the token and the address of the onboarding service, wherein the onboarding service is operated on behalf of the owner; presenting, by the IHS, the token to a firewall protecting the onboarding service; and in response to the presented token being recognized by the firewall, authorizing, by the firewall, an onboarding session by the IHS with the onboarding service in order to configure the IHS for the owner.

In some embodiments, the onboarding system comprises a FIDO (Fast IDentity Online) Device Onboarding (FDO) system. In some embodiments, the token is provided to the IHS by the rendezvous service as part of a TO1 protocol FDO exchange that is initiated upon the first powering of the IHS. In some embodiments, the token is presented by the IHS to the firewall protecting the onboarding service as part of a TO2 protocol FDO communication. In some embodiments, the token is provided by the owner to the rendezvous service during a TO0 protocol FDO communication. In some embodiments, the token comprises a certificate authority that must be utilized in connection with the firewall protecting the onboarding service. Some embodiments may include rejecting, by the IHS, the onboarding session with the onboarding service when the firewall does not utilize a connection that is secured with credential that are validated by the certificate authority. Some embodiments may include signing of the token by the rendezvous service, wherein the signed token includes an expiration and wherein the firewall rejects tokens with expired signatures.

### BRIEF DESCRIPTION OF THE DRAWINGS

The present invention(s) is/are illustrated by way of example and is/are not limited by the accompanying figures. Elements in the figures are illustrated for simplicity and clarity, and have not necessarily been drawn to scale.

FIG. 1 is a diagram illustrating certain components of an IHS configured, according to some embodiments, for secure onboarding and management of the IHS.

FIG. 2 is a diagram illustrating certain components of a system and certain steps of methods, according to some embodiments, for secure onboarding and management of an IHS.

FIG. 3 is a sequence diagram illustrating the messaging sequence of the prior art FDO TO0 protocol.

FIG. 4 is a sequence diagram illustrating the messaging sequence of the prior art FDO TO1 protocol.

### DETAILED DESCRIPTION

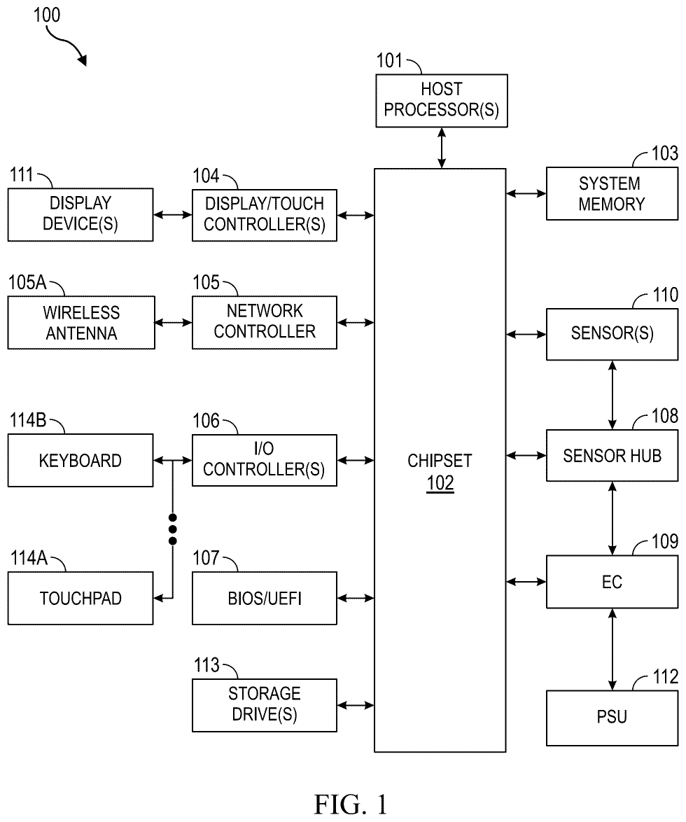

FIG. 1 is a diagram illustrating examples of components of an Information Handling System (IHS) manufactured and configured, according to some embodiments, to support secure onboarding and management of the IHS. FIDO Device Onboarding (FDO) defines a system to allow an IHS to be manufactured without prior knowledge of the ultimate owner of the IHS, and thus without prior knowledge of the owner's control plane and/or FDO onboarding service to which the IHS should connect. FDO defines a discovery mechanism, by which the IHS may reach out to a well-known, previously and globally established rendezvous service on initial power-on of the IHs, such that the rendezvous server may simply redirect the IHS to the onboarding service. However, as described in additional detail below, the onboarding service is vulnerable to malicious actions such as DDOS (Distributed Denial of Service) attacks. Accordingly, in some embodiments an IHS may be factory provisioned to utilize a rendezvous service that supports secure onboarding of the IHS, while also protecting the onboarding service from malicious activity.

As illustrated, IHS 100 includes host processor(s) 101. In various embodiments, IHS 100 may be a single-processor system, a multi-processor system including two or more processors and/or processor cores. Host processor(s) 101 may include any processor capable of executing program instructions, such as a PENTIUM processor, or any general-purpose or embedded processor implementing any of a variety of Instruction Set Architectures (ISAs), such as an x86 or a Reduced Instruction Set Computer (RISC) ISA (e.g., POWERPC, ARM, SPARC, MIPS, etc.). IHS 100 utilizes a chipset 102 that may include one or more integrated circuits that are connected to processor 101. In the embodiment of FIG. 1, processor 101 is depicted as separate component from chipset 102. In other embodiments, all of chipset 102, or portions of chipset 102 may be implemented directly within the integrated circuitry of the processor 101. Chipset 102 provides the processor(s) 101 with access to a variety of resources of the IHS.

In some embodiments, processor 101 may include an integrated memory controller that may be implemented directly within the circuitry of the processor 101, or the memory controller may be a separate integrated circuit that is located on the same die as the processor 101. The memory controller may be configured to manage the transfer of data to and from the system memory 103 of the IHS 100 via a high-speed memory interface. The system memory 103 provides the processor 101 with a high-speed memory that may be used in the execution of computer program instructions by the processor 101. Accordingly, system memory 103 may include memory components, such as such as static RAM (SRAM), dynamic RAM (DRAM), NAND Flash memory, suitable for supporting high-speed memory operations by the processor 101. In certain embodiments, system memory 103 may combine both persistent, non-volatile memory and volatile memory. In certain embodiments, the system memory 103 may be comprised of multiple removable memory modules.

As illustrated, a variety of resources may be coupled to the processor(s) 101 of the IHS 100 through the chipset 102. For instance, chipset 102 may be coupled to a wireless network controller 105 that may support different types of wireless network connectivity. In certain embodiments, wireless network controller 105 may include one or more Network Interface Controllers (NICs). In some embodiments, wireless network controller 105 may utilize one or more multiple wireless antenna 105a and may implement hardware for communicating via a specific networking technology, such as Wi-Fi, BLUETOOTH, and mobile cellular networks (e.g., CDMA, TDMA, LTE). In some embodiments, network controller 105 may support wireless Wi-Fi communications, and my include a Wi-Fi controller or wireless NIC card by which IHS 100 transmits and receives wireless Wi-Fi signals.

Chipset 102 also provides processor 101 with access to one or more storage drives 113. In various embodiments, storage drives 113 may be integral to the IHS, or may be external to the IHS 100. In some embodiments, storage drive(s) 113 may be accessed via a storage controller that may be an integrated component of the storage device. In some embodiments, a storage controller may be a system-on-chip function of processor(s) 101. Storage drive(s) 113 may be implemented using any memory technology allowing IHS 100 to store and retrieve data. For instance, storage drive(s) 113 may be a magnetic hard disk storage drive or a solid-state storage drive. In certain embodiments, storage drive(s) 113 may include a system of storage devices, such as a cloud drive accessible via network interface 105.

As illustrated, IHS 100 also includes a BIOS (Basic Input/Output System) 107 that may be stored in a non-volatile memory accessible by chipset 102. In some embodiments, BIOS 107 may be implemented using a dedicated microcontroller coupled to the motherboard of IHS 100. In some embodiments, BIOS 107 may be implemented as operations of embedded controller 109. Upon powering or restarting IHS 100, processor(s) 101 may utilize BIOS 107 instructions to initialize and test hardware components coupled to the IHS 100. The BIOS 107 instructions may also load an operating system for use by the IHS 100. The BIOS 107 provides an abstraction layer that allows the operating system to interface with certain hardware components of the IHS 100. The Unified Extensible Firmware Interface (UEFI) was designed as a successor to BIOS. As a result, many IHSs utilize UEFI in addition to or instead of a BIOS. As used herein, BIOS is intended to also encompass UEFI.

In various embodiments, one or more display devices 111 may be coupled to IHS 100. Display device(s) 111 may include a plurality of pixels that are arranged in a matrix and are configured to display visual information. Display device(s) 111 may include Liquid Crystal Display (LCD), Light Emitting Diode (LED), organic LED (OLED), or other thin film display technologies. IHS 100 may support an integrated display device, such as a display integrated into a laptop, tablet, 2-in-1 convertible device, or mobile device. In some embodiments, IHS 100 may be a hybrid laptop computer that includes dual integrated displays incorporated in both of the laptop panels. IHS 100 may also support use of one or more external displays, such as external monitors that may be coupled to IHS 100 via various types of couplings. In some embodiments, chipset 102 may provide access to one or more display device(s) 111 via a graphics processor and/or GPU (Graphics Processor Unit). In certain embodiments, a graphics processor may be comprised within a video or graphics card or within an embedded controller installed within IHS 100. In certain embodiments, a graphics processor may be integrated within processor 101, such as a component of a system-on-chip.

In some embodiments, one or more of the display devices 111 may be capable of receiving touch inputs from a user. In some embodiments, these touch inputs received via display devices 111 may be processed by a touch controller 104 that may be separate from other controllers used the display of content. In some embodiments, the touch controller 104 functions may be implemented by a display controller. In some embodiments, touch controller 104 may be an embedded component of an individual display device 111, such that IHS 100 may support multiple distinct touch controllers 104, each processing inputs from a separate display device 111, such as integrated touch controllers 104 processing inputs from separate display panels of a laptop IHS.

Chipset 102 may also provide access to one or more user input devices, in some instances using one or more I/O controller(s) 106 or the like. Examples of user input devices include, but are not limited to a touchpad (such as a touchpad integrated in the palm rest area of a laptop IHS), keyboard 114B and mouse 114C. In some embodiments, a single controller may support multiple of these user input devices, such as a keyboard controller that detects inputs from the keyboard 114B and also detects inputs from a touchpad 114 integrated in the palm rest, and also detects mouse 114C inputs detected by buttons included on or under a palm rest of an laptop IHS 100. In some embodiments, other user input devices supported through the operation of I/O controller(s) 106 may include a stylus, microphone(s) and camera(s) that may each be integrated or external components of an IHS 100.

Some IHS 100 embodiments may utilize an embedded controller 109 that may

be a motherboard component of IHS 100 and may include one or more logic units. In certain embodiments, embedded controller 109 may operate from a separate power plane from the main processors 101 of IHS, and thus from the operating system functions of IHS 100. In some embodiments, firmware instructions utilized by embedded controller 109 may be used to operate a secure execution environment that may include operations for providing various core functions of IHS 100, such as power management and management of certain operating modes of IHS.

In some embodiments, IHS 100 may be manufactured and factory provisioned such that firmware instructions of embedded controller 109 are utilized at the initial powering of the IHS to initiate a connection with a rendezvous service 255. In such embodiments, factory-provisioned firmware instructions utilized by the embedded controller 109 may initiate a secure execution environment upon initial powering of the IHS, where this environment operates without booting the operating system of the IHS. From this secure environment, the embedded controller 109 may initiate a connection with a rendezvous service 255 specified by the manufacturer 270 in the factory provisioned firmware of the embedded controller. As described in additional detail below, the rendezvous service 255 may provide the embedded controller 109 a token for use in bypassing firewall or other security gateways that protect an onboarding service that will configure the IHS 100 for operation by a specific customer 275. In certain embodiments, the embedded controller may be configured to utilize a token provided from the factory-provisioned rendezvous service 255 (e.g., controlled by manufacturer 270) in bypassing firewall restrictions used by an onboarding services 260, and may also be configured to initiate such connections with an onboarding services 260 only through TLS connections that are validated by a factory-provisioned certificate authority, such as a certificate authority trusted by both a manufacture 270 and customer's 270 of that manufacturer.

For instance, embedded controller 109 may implement operations for interfacing with a power supply unit (PSU) 112 in managing power for IHS 100. In certain instances, the operations of embedded controller may determine the power status of IHS 100, such as whether IHS 100 is operating strictly from battery power, whether any charging inputs are being received by power supply unit 112, and/or the appropriate mode for charging the one or more battery cells of the IHS using the available charging inputs. Embedded controller 109 may support routing and use of power inputs received via a USB port and/or via a power port supported by the power supply unit 112. In addition, operations of embedded controller 109 may interoperate with power supply unit 112 in order to provide battery status information, such as the state of charge of the battery.

In some embodiments, embedded controller 109 may also implement operations for detecting certain changes to the physical configuration of IHS 100 and managing the modes corresponding to different physical configurations of IHS 100. For instance, where IHS 100 is a laptop computer or a convertible laptop computer, embedded controller 109 may receive inputs from a lid position sensor that may detect whether the two sides of the laptop have been latched together, such that the IHS is in a closed position. In response to lid position sensor detecting latching of the lid of IHS 100, embedded controller 109 may initiate operations for shutting down IHS 100 or placing IHS in a low-power mode. In this manner, IHS 100 may support the use of various power modes. In managing the operation of IHS 100 according to its physical posture, embedded controller 109 may identify any number of IHS physical postures, including, but not limited to: laptop, stand, tablet, or book postures.

IHS 100 may include a wide variety of sensors 110 for use in gathering telemetry data that can be used in the management of operations by the IHS. Sensors 110 may be disposed on or within the chassis of IHS 100, or otherwise coupled to IHS 100, and may include, but are not limited to: electric, magnetic, radio, optical (e.g., camera, webcam, etc.), infrared, thermal (e.g., thermistors etc.), force, pressure, acoustic (e.g., microphone), ultrasonic, proximity, position, deformation, bending, direction, movement, velocity, rotation, gyroscope, Inertial Measurement Unit (IMU), and/or acceleration sensor(s). Sensors 110 may include geo-location sensors capable for providing a geographic location for IHS 100, such as a GPS sensor or other location sensors configured to determine the location of IHS 100 based on triangulation and network information. Various sensors, such as optical, infrared and sonar sensors, may be used in the detection of individuals in proximity to the IHS 100 and/or in other forms of user presence detection.

In some embodiments, sensor hub 108 may utilize data from inertial movement sensors, that may include accelerometer, gyroscope, and magnetometer sensors, to determine the current orientation and any movement of IHS 100 (e.g., IHS 100 is motionless on a relatively flat surface, IHS 100 is being moved irregularly and is likely in transport, the hinge of IHS 100 is oriented in a vertical direction). In certain embodiments, the sensor hub 108 may also include capabilities for determining a location and movement of IHS 100 based on triangulation of network signal and based on network information provided by the OS or by a network interface.

In some embodiments, an IHS 100 may not include all of the components shown in FIG. 1. In other embodiments, an IHS 100 may include other components in addition to those that are shown in FIG. 1. Furthermore, some components that are represented as separate components in FIG. 1 may instead be integrated with other components. For example, in certain embodiments, all or a portion of the operations executed by the illustrated components may instead be provided by components integrated into processor(s) 101 as systems-on-a-chip.

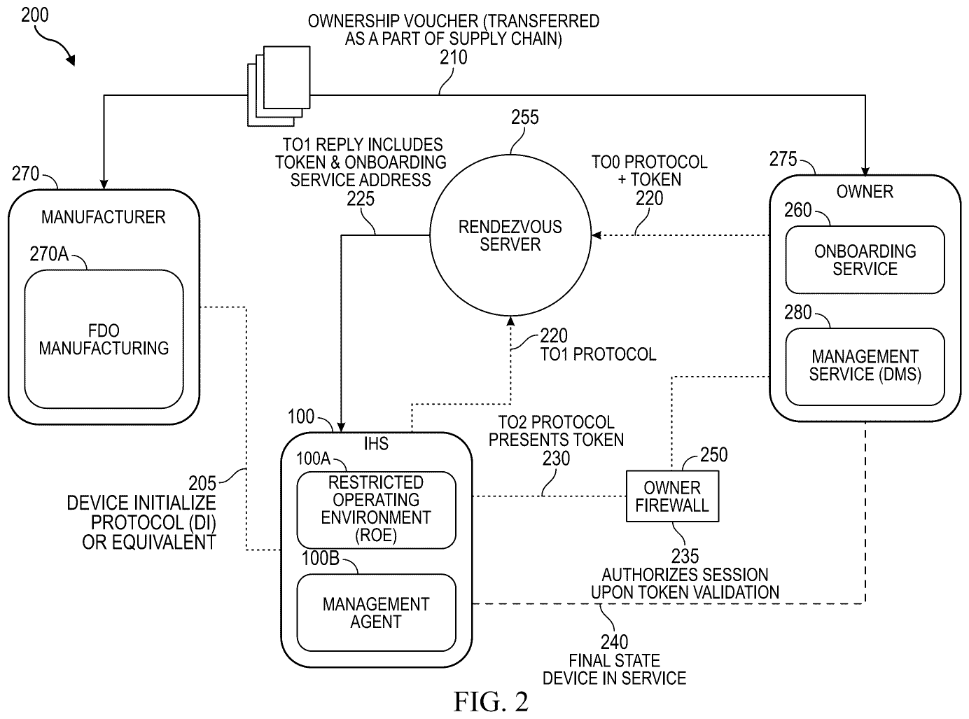

FIG. 2 is a diagram illustrating certain components of a system and certain steps of methods, according to some embodiments, for secure onboarding and management of an IHS 100. As described, FDO defines protocols that allow a device, such an IHS 100, to be manufactured 270a without prior knowledge of its ultimate owner 275, or the onboarding service 260 (or the management service 280) to which the IHS 100 should connect upon being powered for the first time. FDO defines a discovery mechanism, by which IHS 100 connects to a global rendezvous service 255 on initial power-on of the IHS. As described in additional detail below, the rendezvous service 255 redirects the IHS 100 to the onboarding service 260 specified by the owner 275, using the messaging sequence of the FDO TO1 protocol illustrated in FIG. 5.

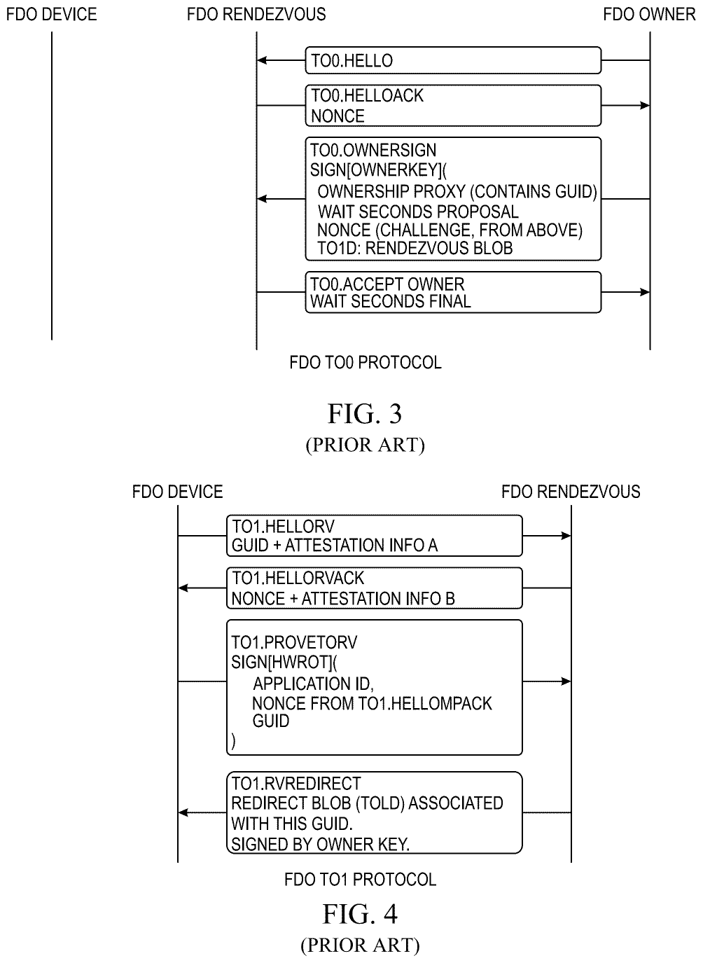

Before the IHS 100 can be onboarded, the IHS owner 270 must inform the rendezvous service 255 of their ownership of the IHS 100 and must instruct the rendezvous service 255 to direct this IHS 100 to an onboarding service 275 specified by the owner. In existing systems, this process may be done via the FDO TO0 protocol illustrated in the messaging sequence illustrated in FIG. 3. Ultimately, after the rendezvous service 255 has instructed the IHS 100 on the address to use in initiating a connection with the onboarding service 260, the IHS 100 may then connect to the onboarding service 260 via a FDO protocol called TO2, where the IHS 100 and its owner 275 will mutually attest/identify each other. After such assurances have been met, the owner's onboarding service 260 is determined to be legitimate and trustable by the IHS 100, and the onboarding services 260 is assured that the IHS 100 is legitimate and was built and delivered by manufacturer 270. Once attestations are satisfied, at 240, the onboarding service has credentialed the IHS 100 to communicate in steady-state with a management service 280.

In existing TO0 protocol exchanges illustrated in FIG. 3, the onboarding service 260 instructs the global rendezvous service 255 to send IHS 100 to the onboarding service 260. In existing TO1 protocol exchanges illustrated in FIG. 4, the IHS 100 is powered for the first time and initiates a communication with the rendezvous service 255 seeking directions to an onboarding service 260 of the customer 275. During a TO2 protocol exchange, IHS 100 connects to the onboarding service 260 specified by the rendezvous service 255 and mutual credentialing and onboarding ensues. During an FDO steady-state, at 240, IHS 100 uses credentials established during a TO2 communication for further connection to applications.

Whereas FDO is an onboarding protocol which may be used to establish credentials for an IHS 100, an IHS is nonetheless uncredentialled with respect to the owner's control plane at the time of manufacturing. The rendezvous service 255 is a globally-available service. It must be highly-available, such as available as a cloud resource such that it is open and accessible to everyone. Rendezvous operations utilizing the TO1 protocol may or may not run using TLS since IHSs accessing the rendezvous service 255 are new, unknown, and uncredentialed. An IHS 100 contacting the rendezvous service 255, or other FDO systems, have not yet been credentialed or authorized. For this reason, it is difficult for a rendezvous service 255 (or a firewall, filter, traffic analyzer, CDN or other security gateway operating to protect the rendezvous service) to safely redirect an IHS 100 to an onboarding services 260 based only on this initial rendezvous connection. Since the rendezvous protocol provides an initial authentication of IHSs requesting onboarding, it should be a scalable, global service and must support requests from un-authenticated clients. As a global service, a rendezvous protocol should be scalable to meet any demand, including demands which would be placed onto it by attackers, such as in a DDOS scenario.

Rendezvous service 255 may implement the existing FDO protocols illustrated in FIGS. 3 and 4 that may be modified in embodiments as described below in order to support use of tokens that may be used in identifying an IHS by a firewall or other gateways that protect the onboarding services 260. The first step of the TO1 protocol exchange for redirecting an IHS 100 to an onboarding service 260 includes an attestation check (i.e. authentication) of the IHS initiating the protocol exchange. Whereas, in a DDOS scenario, there is no previous authentication that a fronting service such as a firewall can use in filtering onboarding requests, embodiments provide scalable rendezvous and onboarding protocols that include a short path with few operations required to filter illegitimate network traffic and to beging authenticating an IHS, thus supporting onboarding in a manner that mitigates problems caused by denial of service attacks.

Onboarding services 260 may vary, depending on the application and the characteristics of the control plane utilized by owner 275. On one hand, a single, monolithic, global, cloud-based control plane (e.g., a combination of an onboarding service 260 and management service 280 in use by a customer 275) may be used for a worldwide set of loT sensors (e.g., Smart Lightbulbs made by a major manufacturer). But on the other hand, smaller, single-purpose, single-tenant control planes may be used for specific end users, as might be the case in systems where an IHS 100 manufacture may maintain a separate instance of a cloud-based control plane for each customer. Such a control plane may be smaller, less scalable service and may support a single IHS 100 (or cluster) for a specific customer 275.

For smaller, less scalable control planes, the ability to defend itself against a denial-of-service (DDOS) attack is limited. Thus, such customer control planes require the assistance of a CDN or distributed gateway system, such as a firewall 250, to protect the onboarding service 260 and the rest of the control plane. For both smaller control planes and larger distributed DNS control planes, the rendezvous service 255 may direct connections to a large network of front-end gateways or firewalls 250, which present a larger filtering surface area that is capable of leveraging additional computing resources at the problem of filtering legitimate network traffic, thus sparing an onboarding service 260 from an onslaught of connection requests triggered by a DDOS attack. The challenge being that any traffic from devices, nefarious or otherwise, to an onboarding server 260 has not yet been authenticated, such that there are limited deterministic options for a gateway, such as firewall 250, to discern valid requests from nefarious ones.

This results in the problem of protecting an onboarding service 260 and other components of a control plane from malicious DDOS attacks. When the incoming traffic expected by the firewall will not be from authenticated devices, there is no deterministic way for a firewall 250 or other gateway to discern valid requests versus malicious ones. Embodiments rely on an overlooked premise: in order to complete the FDO TO2 protocol in which an IHS 100 requests onboarding, an IHS 100 is first directed by a rendezvous service 255 to a specific onboarding service 260.

In embodiments, a global rendezvous service 255 may be a scalable, monolithic service that may be operated by the manufacturer 270 of IHS 100. As the TO1 rendezvous protocol includes an authentication check on the initiating IHS 100, upon success of this rendezvous authentication, at 225, rendezvous service 255 may include a token in its response message to the IHS 100. In some embodiments, the token may be included rendezvous service 255 in the on the final step of the TO1 protocol exchange (i.e. as part of the TO1.RVRedirect message).

This token provided to the IHS 100 may be an OAuth (Open Authorization) token, which may be identifiable by the owner firewall 250, where the token authorizes the possessor to initiate a session that bypasses the firewall 250 with the onboarding service 260. After completing a TO1 protocol rendezvous exchange according to embodiments, the IHS 100 presents this token (in an HTTP header, for example), at 230, in the subsequent TO2 onboarding connection request. Even though this TO2 request is issued to the onboarding service 260, and not the rendezvous service 255, the IHS 100 would nonetheless be recognized by the firewall 250 which is fronting the onboarding service 260, even if the firewall 250 never interfaces with the rendezvous service 255. By presenting the token that was issued by the owner 275 as part of the TO0 protocol exchange, at 235, the firewall 250 authorizes traffic from the IHS 100 to by bypass the firewall restrictions and flow to the onboarding service 260.

In this manner, embodiments provide a mechanism for the firewall 250, at 235, during TO2 operations, to restrict that traffic that is allowed to reach an onboarding services 260, even though the IHS 100 has yet to be fully authenticated. Embodiments thus leverage the authentication completed in the TO1 rendezvous protocols, and consequently the trust that the TO2 infrastructure places in the TO1 infrastructure. Embodiments may implement tokens in a variety of manners. In some embodiments, the token may be generated by a rendezvous service 255 and provided directly or indirectly (e.g., by the owner) to the firewall 250, with wide variance in the format and type of token that may be utilized. Some embodiments may utilize standard HTTP OAuth token and some embodiments may utilize a static, fixed, pre-determined or well-known token that is shared between the firewall 250 and onboarding service 260 and also provided to the rendezvous service 255.

Embodiments may utilize a fully authenticated TLS sessions during both TO1 and TO2 protocol sessions in order to prevent listeners from stealing and misusing tokens. As described in additional detail below, some embodiments may add an expiration time to a signed version of the token, in order to prevent impacts of theft and misuse. In some embodiments, a token may be signed using a signing key of the rendezvous service 255, such that firewall 250 may validate the authenticity of received tokens and may also confirm the token has not expired. In some embodiments, the rendezvous service 255 may utilize an API supported by firewall 250 in order to request a token from the firewall. In such embodiments, the token supplied by the firewall 250 may be provided by the owner 275 for use in onboarding a specific IHS.

As provided above, a global rendezvous service 255 and an onboarding service 260 may be operated by the same trusted entity. Therefore, a global rendezvous service 255 may have access to keys, secrets or other authorizations, such that it may be trusted to issue tokens for the firewall 250 protecting the onboarding service 260. However, FDO supports a single, global rendezvous service 255 that facilitates onboarding by a multitude of different onboarding services 260, including ones that are separately owned and controlled, and/or without having any first-hand knowledge of some of the onboarding services.

In the TO1 protocol, the last step redirects IHS 100 to the address of the onboarding service 260. This onboarding information may be provided via the TO0 protocol to rendezvous service 255 for onboarding that specific IHS 100. In this manner, the onboarding service 260, or other function of the owner's 375 control plane, may instruct the rendezvous service 255 to direct a specific IHS 100 to a specific onboarding service 260. In some embodiments, the onboarding service 260 may instruct the rendezvous service 255 to direct a specific IHS 100 to a specific firewall 250, or set of firewalls, where these firewalls have been configured to authorize sessions using this specific token that has been provided to this specific IHS.

Embodiments support secure onboarding of IHSs by its owner 275 using third-party onboarding services 260 and generic, global rendezvous services 255 that do not include any specific integrations for onboarding or management of the IHS 100. In order to configure onboarding of an IHS, a TO0 protocol message is provided to the rendezvous service 255 by the owner 275, where this message specifies an onboarding service 260 to which the IHS is to be directed for onboarding. In embodiments, a token may be included in the TO0 protocol messages that is generated by owner 275 and provided to the rendezvous service 255 in instructing the redirection of the IHS to an onboarding services 260 selected by the owner for onboarding of this particular IHS. In some embodiments, the token may be included by the owner 275 in the “TO0.OwnerSign” portion of the message that is delivered to the rendezvous service 255 as part of the TO0 protocol message.

In some embodiments, at 220, the TO0 rendezvous message provides the rendezvous service 255 with address information for directing the IHS 100 to the onboarding service 260 and also provides the token to be presented by the IHS. In such embodiments, the IHS 100 is powered and initiates a connection with the rendezvous service 255 and receives the address of an onboarding service 260 and the token provided by the owner 275. Upon completion of the rendezvous protocol, the IHS may include this token in the TO1 messages issued to the onboarding services 260. In some embodiments, the token may be subsequently included by the IHS in an HTTP header of the TO1 request issued to the onboarding service 260 via the firewall 250. In this manner, embodiments providing a mechanism in which any onboarding service 260 may be protected by any firewall 250 that is configured to recognize tokens provided by the owner 275. Moreover, the global rendezvous service 255 needs no special knowledge or credentials to handle such a scenario since it may merely relay the token provided by the owner 275 to a specific IHS 100, as long as the IHS is successfully identified by the rendezvous service 255 as part of the TO1 protocol handshake.

However, long-running tokens may be vulnerable to potential theft, where they could be stolen and used by any number of attackers at any later time. It is difficult to put a time limit on tokens in onboarding scenarios, because it is unknown when the device will attempt to onboard. Through the use of signed tokens where the signature validity is time limited, embodiments provide a mechanism in which onboarding service 260 may instruct firewall 250 that an IHS 100 is recognized and to authorize sessions by that IHS, while placing limited trust in the rendezvous service 255.

In some embodiments, a public key of the global rendezvous service 255 may be made generally available, such as to providers of onboarding services 260. Using this public key, the onboarding service 260 may instruct the firewall 250 to trust a token if it is signed by this public key of the rendezvous service 255. Upon a rendezvous request, at 220, by the IHS 100, the rendezvous service 255 may then sign the token used to gain authorization by the firewall 250 of the onboarding service 260 to which the IHS is being directed. In some embodiments, the signed token may include a time restriction specified by the rendezvous service 255.

In this manner, the time limits on a token used for onboarding begins running upon receipt of an initial onboarding request, at 220, from the IHS 100. As described, the token signed by the rendezvous service 255 may be provided, at 225, in the TO1 rendezvous reply message to the IHS. Such embodiments increase security though additional trust in rendezvous service 255, thus providing the ability to issue tokens with limited times, and as a result preventing long-term theft and misuse of credentials. In the event that a rendezvous service 255 key used to sign tokens is stolen or misappropriated, the onboarding service 260 provider may rotate the key in use by the firewall 250 in order to disable any further use of the current key.

Prior to onboarding, an IHS 100 has not been positively identified or validated by the onboarding service 260, thus the IHS is unknown to the onboarding service 260, but there is also no way for the IHS 100 to know a priori whether an onboarding service 260 (or firewall 250 fronting an onboarding service) is genuine or nefarious. Existing systems may rely on the existing TO2 protocol procedures for mutual validation of identity, thus providing some protection from a nefarious onboarding service 260. However, in embodiments that use a token provided to the IHS by the rendezvous service 255 as proof that the IHS 100 should be authorized by firewall 250, a nefarious onboarding service 260 (or firewall 250 fronting the service) could be used to steal that token. Best practices may limit the scope of such theft of a token, for example by placing restrictions on use of the token, such as only when the token is presented from a specific originating IP address, imposing time restrictions on the token, etc.

Embodiments reduce the possibility of theft of a token by a nefarious onboarding service 260 or firewall 250. In addition to providing a token, the rendezvous service 255 may also specify a specific certificate authority (Root, Intermediate or Server) that must be used by the firewall 250 in establishing secured communication sessions in order for the IHS 100 to trust the firewall. Based on being instructed to trust only firewalls using a specific certificate authority, the IHS 100 may initiate a TLS connection with the onboarding service 260 via the firewall 250 only when the TLS connection is secured according to credentials validated by this specific certificate authority that is provided along with the token. In this manner, the IHS 100 may require TLS connections for use in validation of tokens by firewall 250 to be secured using a specific certificate authority that is trusted by owner 275. Failure to utilize a connection secured by this certificate authority may imply that the firewall 250 is being spoofed, and presentation of the token to the firewall 250 during TO2 may provide an opportunity to steal this token.

As described, FDO compliance may include the generation of FIDO (Fast IDentity Online) vouchers that are useable in tracking the ownership of devices starting from their manufacture and through the provisioning and onboarding for deployment. A voucher management system may be a cloud-based or other remote system used in managing ownership of a hardware device or system. In some embodiments, the certificate authority to be used by the firewall 250 and onboarding service 260 in order to be trusted by the IHS 100 may be specified in an FDO ownership voucher associated with the IHS, and that may be transferred, at 210, as part of the transfer of ownership of the IHS 100 from manufacturer 270 to owner 275. In some embodiments, the described token and onboarding service 260 address information may also be included in the FDO ownership voucher that is transferred, at 210. In such embodiments, the ownership voucher that includes such information may be provided to the rendezvous service 255 for conveyance to the IHS 100 during the TO1 rendezvous phase, at 225, that redirects the IHS to the onboarding service 260.

It should be understood that various operations described herein may be implemented in software executed by logic or processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. A method for secure onboarding of an Information Handling System (IHS), the method comprising:
providing a rendezvous service of an onboarding system with an address of an onboarding service and a token that are both to be provided to the IHS;
powering the IHS for a first time upon a transfer of the IHS to an owner;
upon the first powering of the IHS, initiating, by the IHS, a connection with the rendezvous service of the onboarding system;
providing, by the rendezvous service, the IHS the token and the address of the onboarding service, wherein the onboarding service is operated on behalf of the owner;
presenting, by the IHS, the token to a firewall protecting the onboarding service; and
in response to the presented token being recognized by the firewall, authorizing, by the firewall, onboarding communications by the IHS with the onboarding service in order to configure the IHS for the owner.

2. The method of claim 1, wherein the onboarding system comprises a FIDO (Fast IDentity Online) Device Onboarding (FDO) system.

3. The method of claim 2, wherein the token is provided to the IHS by the rendezvous service as part of a TO1 protocol FDO exchange that is initiated upon the first powering of the IHS.

4. The method of claim 2, wherein the token is presented by the IHS to the firewall protecting the onboarding service as part of a TO2 protocol FDO communication.

5. The method of claim 2, wherein the token is provided by the owner to the rendezvous service during a TO0 protocol FDO communication.

6. The method of claim 2, wherein the token comprises a certificate authority that must be utilized in connecting with the firewall protecting the onboarding service.

7. The method of claim 6, further comprising rejecting, by the IHS, the onboarding session with the onboarding service when the firewall does not utilize a connection that is secured with credentials that are validated by the certificate authority.

8. The method of claim 1, further comprising signing of the token by the rendezvous service, wherein the signed token includes an expiration and wherein the firewall rejects tokens with expired signatures.

9. An IHS (Information Handling System) comprising:
one or more processors;
one or more memory devices coupled to the processors, the memory devices storing computer-readable instructions that, upon execution by the processors, cause the IHS to:
power the IHS for a first time upon a transfer of the IHS to an owner;
upon the first powering of the IHS, initiate a connection with a rendezvous service of an onboarding system;
receive, from the rendezvous service, an address of an onboarding service and a token, wherein the onboarding service is operated on behalf of the owner; wherein the address and token are provided to the rendezvous service by the owner;
present the token to a firewall protecting the onboarding service; and
in response to the presented token being recognized by the firewall, utilize a connection authorize by the firewall to initiate an onboarding session with the onboarding service in order to configure the IHS for the owner.

10. The IHS of claim 9, wherein the onboarding system comprises a FIDO (Fast IDentity Online) Device Onboarding (FDO) system.

11. The IHS of claim 10, wherein the token is provided to the IHS by the rendezvous service as part of a TO1 protocol FDO exchange that is initiated upon the first powering of the IHS.

12. The IHS of claim 10, wherein the token is presented by the IHS to the firewall protecting the onboarding service as part of a TO2 protocol FDO communication.

13. The IHS of claim 10, wherein the token is provided by the owner to the rendezvous service during a TO0 protocol FDO communication.

14. The IHS of claim 10, wherein the token comprises a certificate authority that must be utilized in connection with the firewall protecting the onboarding service.

15. A system for secure onboarding of an Information Handling System (IHS), the system comprising:
a rendezvous service of an onboarding system that is provided with an address of an onboarding service and a token that are both to be provided to the IHS;
the IHS comprising one or more processors and one or more memory devices coupled to the processors, the memory devices storing computer-readable instructions that, upon execution by the processors, cause the IHS to
power the IHS for a first time upon a transfer of the IHS to an owner;
upon the first powering of the IHS, initiate a connection with the rendezvous service of an onboarding system;
receive, from the rendezvous service, the address of an onboarding service and a token; and
present the token to a firewall protecting the onboarding service
the onboarding service that is protected by the firewall, wherein in response to the presented token being recognized by the firewall, the firewall authorizes onboarding communications by the IHS with the onboarding service in order to configure the IHS for the owner.

16. The system of claim 15, wherein the onboarding system comprises a FIDO (Fast IDentity Online) Device Onboarding (FDO) system.

17. The system of claim 16, wherein the token is provided to the IHS by the rendezvous service as part of a TO1 protocol FDO exchange that is initiated upon the first powering of the IHS.

18. The system of claim 16, wherein the token is presented by the IHS to the firewall protecting the onboarding service as part of a TO2 protocol FDO communication.

19. The system of claim 16, wherein the token is provided by the owner to the rendezvous service during a TO0 protocol FDO communication.

20. The system of claim 16, wherein the token comprises a certificate authority that must be utilized in connection with the firewall protecting the onboarding service.
